(19) United States
(12) Patent Application Publication
(10) Pub. No.: US 2018/0336795 A1
(43) Pub. Date: Nov. 22, 2018

(54) PERMISSION-STATUS CONDITIONING SYSTEM APPARATUS AND METHOD

(71) Applicant: Steven J. Swanson, Metairie, LA (US)

(72) Inventor: Steven J. Swanson, Metairie, LA (US)

(21) Appl. No.: 15/596,329

(22) Filed: May 16, 2017

(51) Int. Cl. G09B 19/00; G09B 5/00; A41D 19/00; A41D 1/00

(52) U.S. Cl. CPC G09B 19/00; G09B 5/00; A41D 2600/00; A41D 1/002; A41D 19/0031; A41D 19/0024

(57) ABSTRACT

A permission-status conditioning apparatus and method for conditioning a trainee to obtain and wait for permission from a trainer before touching a target object, providing a control unit having a wireless permission-transmitting unit adapted to transmit the granting of permission by the trainer, and a permission unit adapted to be worn by the trainee by incorporation onto an article of clothing, such as a glove, neck strap, band, or badge, having a permission-receiving unit to receive a wireless signal sent by the permission-transmitting unit indicating whether permission is granted by the trainer, and at least one permission indicator, such as a light or sound, indicating to the trainee whether permission is granted by the trainer.

### BACKGROUND

This invention provides a permission-status conditioning apparatus and method for conditioning a trainee to obtain and wait for permission from a trainer before touching a target object.

The trainee can be a child of an age where self-control for touching or picking up certain dangerous or breakable objects needs to be taught. The trainer, for example, could be a parent of such a child. In such a situation, the target objects can be breakable objects, such as figurines, vases, or artworks displayed on a shelf, which are tempting for a child to touch and handle, but which are also appropriate for the child to touch and handle under certain conditions, and when permission is given to touch or handle the object. The target object could also be a tool or a cooking utensil, which might be appropriate for a child to handle when given permission, but which might be dangerous for the child to handle at other times. The idea that touching would be permitted sometimes, and under some conditions, but would be prohibited at other times, under other conditions, is more nuanced than the absolute prohibitions or permissions that the child may have been presented with in an earlier stage of development. A tool for conditioning the child to learn, and dynamically adapt, to these changing permissions is therefore desirable.

As another example, the trainee may be an adult performing a potentially dangerous task. In such a situation, certain actions should not be taken until permission, indicating that the dangerous conditions are clear or partially clear, is granted.

There exists a need for such a conditioning and permission-status-indicating tool, as the prior art has not provided a system solving the problems encountered by the above situations.

U.S. Publ. No. 2014/0214631 was published on Jul. 31, 2014 by inventor Michael Hansen, and assignee Intermec Technologies Corp., and discloses an “Inventory Assistance Device and Method.” The Hansen device assists with inventory ordering and management. In an embodiment, a personal device may be used by a worker to assist with identifying and retrieving items in an inventory or warehouse setting. The device includes a communications module suited to interface with radio frequency identification (RFID) tags that may be attached to the items to be selected or a bin that holds the items to be selected. If the worker has maneuvered the device close enough to a correct RFID tag, then the device can provide positive feedback to the worker indicating selection of a needed item. Similarly, if the worker has come into communicative proximity with an item not needed, then negative feedback at the device may be initiated. Specifically, the device may be a glove-like embodiment work on the worker's hand.

U.S. Pat. No. 6,478,583, issued on Nov. 12, 2002 to Jocelyn D. Standiford and Candius L. Edgerle for a “Time Monitoring Portable Game System,” covers a child educational entertainment device. The device includes a housing with a display mounted thereon, and a control mechanism positioned within the housing and adapted to prompt a user to enter an amount of time. Once the time has been entered, a decrementing timer is displayed to count down from the entered amount of time. The control mechanism has at least one mode wherein it is adapted to graphically display the decrementing timer. Further, additional modes are included for entertainment purposes. For example, advanced modes may be included for encouraging player to “find” more obscure or interacting objects within the game.

U.S. Pat. No. 7,298,284, invented by James A. Glime, was issued to owner Jaag Plush, LLC on Nov. 20, 2007 for an “Educational Toy Clock.” The toy clock and stuffed animal combination includes a body supporting a clock that defines a timer for setting a time period for disciplinary action. A first leg extends from the body to a first bottom, and a second leg extends from the body to a second bottom. A start message, such as “TIME OUT” is disposed on the first bottom for indicating the beginning of the time period, and an end message, such as “TIME′S UP” is disposed on the second bottom for indicating the termination of the timer period. Two flaps are movable between a start position covering the “TIME'S UP” at the beginning of the time period, and an end position covering the “TIME OUT” at the termination of the time period.

U.S. Pat. No. 7,218,216 issued on May 15, 2007 to inventor Randy S. Uehran and assignee Daktronics, Inc., and covers a “Referee's Wireless Horn Indicator System.” The system was developed to aid a referee in accurately officiating a sports event. The system includes a controller and a sensory receiver. The controller includes the official time clock for the sports event, a control circuit coupled to the official time clock, and a radio transmitter activated by the control circuit for sending a radio signal to the sensory receiver. The sensory receiver is worn by the referee, for instance on the wrist, and includes a radio receiver and a sensory stimulating device (such as a vibrator), both battery-powered. Upon the official time clock reaching zero, a signal is sent by the transmitter to the radio receiver, which in turn activates the sensory stimulating device to impart a tactual signal to the referee, thereby apprizing him of the expiration of the time period.

U.S. Pat. No. 6,560,802, issued to Masaharu Fujii on May 13, 2003 for a “Pillow with Alarm,” was developed as a pillow capable of being highly useful and convenient to a user. An alarm is arranged at a predetermined portion of a stuffed doll, which may be made in imitation of a real or fanciful animal, or the like. The alarm may be actuated through a timer. The timer may be driven through a cell or a spring. The alarm is constructed so as to generate sound, voice, vibration, or light.

U.S. Pat. No. 6,603,711 was issued to Michael A. Calace on Aug. 5, 2003 for a “Remote Timekeeping Device and System for Controlling Sports Clock.” The timekeeping system comprises one or more portable timekeeping devices, each portable timekeeping device being configured to start, stop, and otherwise control a remote timer adapted to maintain an official time, and optionally at least one other time, such as a game clock. Each portable timekeeping device includes a wireless transmitter and a triggering member, whereby activation of the triggering member actuates a wireless signal that is in turn sent to the remote timer in order to stop the official time. The timekeeping system also can include two-way communication between the remote timer and each portable timekeeping device. The two-way communication enables the official time and any other times being maintained by the remote timer to be displayed on each portable device. The portable timekeeping device and system is designed primarily for use with sporting events, and in particular may be applied to hockey, football, and basketball. The portable timekeeping device may preferably be a glove.

U.S. Pat. No. 6,705,919, covering an “Electronic Amusement Device with Long Duration Timer,” was invented by Kevin G. Curran and Charles R. Mahoney and issued to assignee Mattel, Inc. on Mar. 16, 2004. The electronic amusement device includes a housing having an outer side, which is presented to a consumer using the device; an electronic timer in the housing; and a controller. The timer is configured to track time to an end of an extended time period having a length of at least a plurality of weeks and preset in the device before the device is released to the consumer. The timer is further configured to output a signal at the end of the extended period to the controller. The controller is configured to perform at least one task in an initial mode of operation available to the consumer using the device, and to respond to the signal from the timer to enable, for a first time, the performance of at least one new additional mode of operation the controller did not perform before receipt of the timer signal, or to disable a mode of operation it had performed, or to exchange a new mode of operation for a previously-performed mode of operation.

U.S. Pat. No. 8,814,688 issued to Jonathan A. Barney et al. on Aug. 26, 2014 to a “Customizable Toy for Playing a Wireless Interactive Game Having Both Physical and Virtual Elements.” Embodiments of the invention provide a unique interactive game that connects both physical and virtual play environments, and includes multiple dynamic layers in which a participant may complete a variety of challenges and/or tasks. For example, a participant may obtain a physical gaming item, such as a toy, from a retail phase, which is in turn usable in an interactive entertainment phase that provides virtual play via computer animation. The interactive entertainment phase may include multiple interrelated layers such that progress in one or more layers may affect the participant's experience in one or more other layers. The participant may also receive training on how to use and improve the physical gaming item to help achieve one or more special effects or complete one or more adventures and/or quests. During or following the interactive entertainment phase, the participant may use accumulated points and/or powers to redeem prizes and/or compete against other participants, such as in a duel or other face-off challenge.

### SUMMARY OF THE INVENTION

This invention provides a permission-status conditioning apparatus and method for conditioning a trainee to obtain and wait for permission from a trainer before touching a target object, providing a control unit having a wireless permission-transmitting unit adapted to transmit the granting of permission by the trainer, and a permission unit adapted to be worn by the trainee by incorporation onto an article of clothing, such as a glove, neck strap, band, or badge, having a permission-receiving unit to receive a wireless signal sent by the permission-transmitting unit indicating whether permission is granted by the trainer, and at least one permission indicator, such as a light or sound, indicating to the trainee whether permission is granted by the trainer.

### BRIEF DESCRIPTION OF DRAWINGS

Reference will now be made to the drawings, wherein like parts are designated by like numerals, and wherein:

FIG. 1 is a schematic illustration of an embodiment of the permission-status conditioning apparatus and method in use where permission has been granted;

FIG. 2 is a schematic illustration of an embodiment of the permission-status conditioning apparatus and method in use where permission has not been granted;

FIG. 3 is a schematic illustration of an embodiment of the permission-status conditioning apparatus and method where the invention has been incorporated onto a glove and the target object is a breakable figurine;

FIG. 4 is an illustration of different embodiments of the permission-status conditioning apparatus; and

FIG. 5 is an illustration of differently configured embodiments of the permission-status conditioning apparatus incorporated onto a glove.

### DETAILED DESCRIPTION OF THE INVENTION

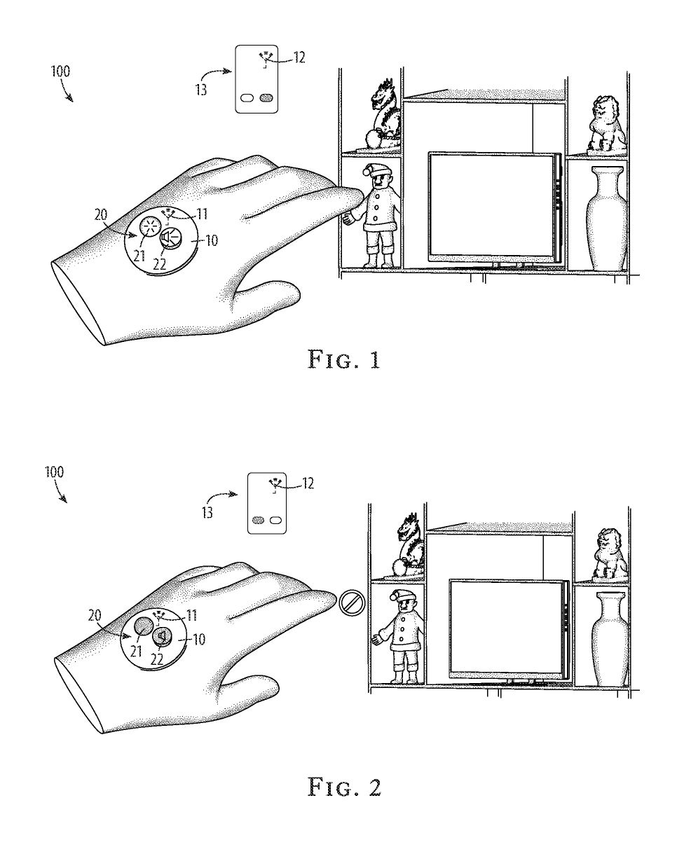

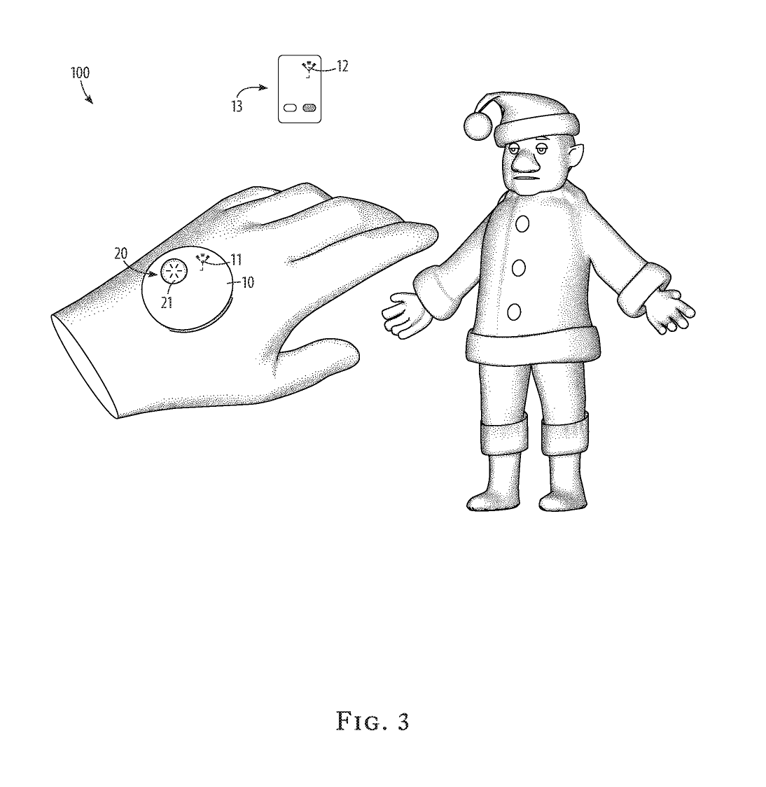

Referring to FIG. 1 & FIG. 2, schematic illustrations of the permission-status conditioning apparatus and method 100 of the invention in use are shown. The target objects are displayed on shelves. The trainee, such as a child, wears a glove incorporating a permission unit 10 on the back. In the schematic illustration of FIG. 1, the trainer, such as a parent, has set the control unit 13 to grant permission for the child to touch one or more of the objects on the shelves. The permission indicator 20 of the permission unit 10 indicates that permission is granted, in the illustrated embodiment, by lighting a positive indicator light 21 and sounding a sound indicator 22. The granted state of permission is transmitted wireles sly from the permission-transmitting unit 12 of the control unit 13 to the permission-receiving unit 11 of the permission unit 10. With such permission granted, the trainee or child is allowed to touch the target object or objects. In FIG. 2, the trainer has set the control unit 13 to deny or withhold granting of permission. This “denial” status has been wirelessly transmitted to the permission unit 10, through the permission-transmitting unit 12 and permission-receiving unit 11. The permission indicators in this embodiment, the positive indicator light 21 and the sound indicator 22, are unlighted and silent. With permission denied or withheld, the trainee or child is not allowed to touch the target object or objects.

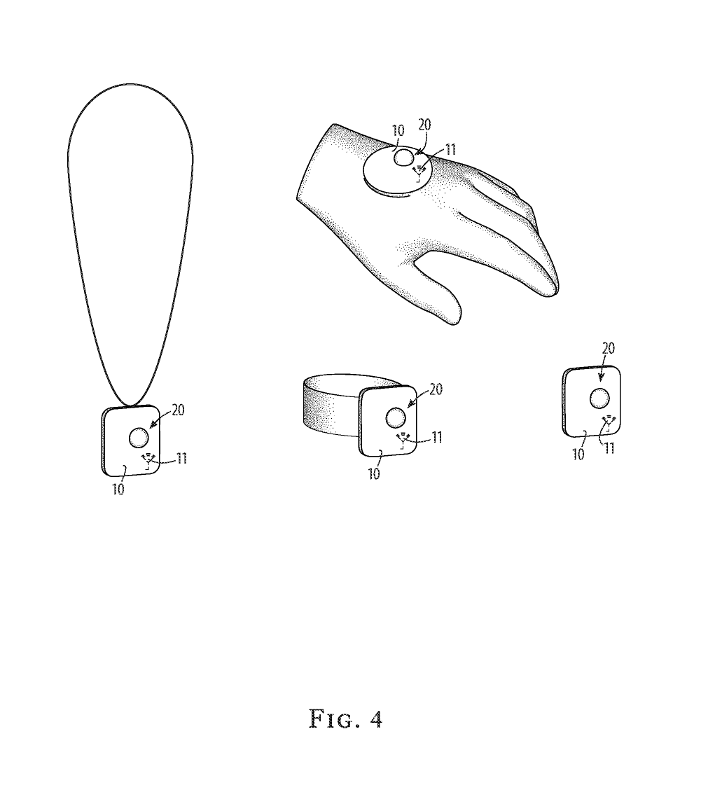

Referring to FIG. 3, the permission unit 10 can provide only a single permission indicator 20, which in the illustrated embodiment is a positive indicator light 21, or can provide more than one permission indicator 20.

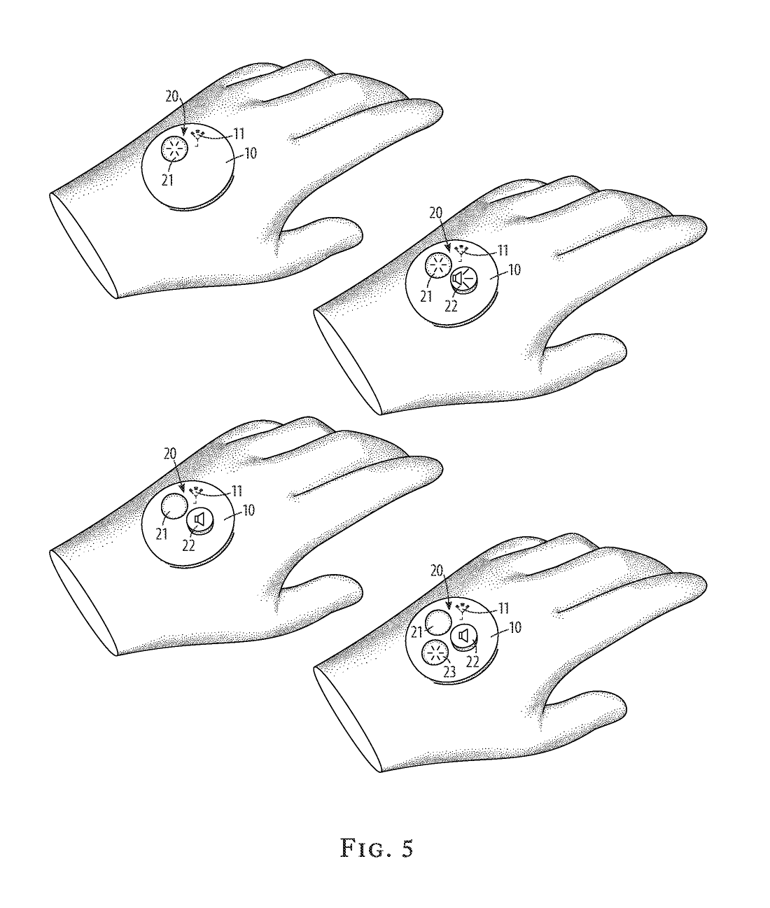

Referring to FIG. 4, the permission unit 10 can be incorporated into a variety of different wearable items. Preferably, the permission unit 10 should be incorporated into an article of clothing that will stay with the trainee or child, in a location where the permission indicator 20 is visible or audible. Illustrated are incorporation onto a glove, a neck band or necklace, a band, such as a wrist band or an arm band, and upon a badge that can be affixed to a garment or to a hat, and can be transferred from garment to garment.

Referring to FIG. 5, different types and different numbers of permission indicators 20 can be used, including a positive indicator light 21, a sound indicator 22, and a negative indicator light 23 that lights up when there is no permission given. The sound indicator 22 can emit a simple buzzer or chime tone. Although continuing to emit the sound during the entire period of granted permission would likely be an irritant, it may be desired in some situations where audial indication is desired. Alternatively, a combination of a continuous light, from a positive indicator light 21, plus a momentary sound from a sound indicator 22, may be a favored combination.

In another embodiment of the permission-status conditioning apparatus, the sound indicator 22 can be used to play speech or music. This speech or music can be electronically generated, or may be pre-recorded for incorporation into the apparatus. For example, a trainer parent can record an oral granting of permission, or of permission regarding a specific target object, and the recording can be played by the sound indicator 22 when appropriate.

Many other changes and modifications can be made in the system and method of the present invention without departing from the spirit thereof. I therefore pray that my rights to the present invention be limited only by the scope of the appended claims.

I claim:

1. A permission-status conditioning apparatus for conditioning a trainee to obtain and wait for permission from a trainer before touching a target object, the permission-status conditioning apparatus comprising:
(i) a control unit adapted to transmit the granting of permission by the trainer, further comprising a permission-transmitting unit adapted to transmit a wireless signal indicating such granting of permission;
(ii) a permission unit adapted to be worn by the trainee by incorporation onto an article of clothing;
(iii) a permission-receiving unit incorporated into said permission unit adapted to receive a wireless signal sent by said permission-transmitting unit indicating whether permission is granted by the trainer; and
(iv) at least one permission indicator incorporated into said permission unit adapted to indicate to the trainee whether permission is granted by the trainer.

2. The permission-status conditioning apparatus of claim 1, where said permission indicator further comprises a positive indicator light.

3. The permission-status conditioning apparatus of claim 1, where said permission indicator further comprises a sound indicator.

4. The permission-status conditioning apparatus of claim 1, where said permission indicator further comprises a negative indicator light.

5. The permission-status conditioning apparatus of claim 1, where said at least one permission indicator further comprises at least two said permission indicators.

6. The permission-status conditioning apparatus of claim 1, where said permission unit adapted to be worn by the trainee by incorporation onto an article of clothing further comprises incorporation onto a glove.

7. The permission-status conditioning apparatus of claim 1, where said permission unit adapted to be worn by the trainee by incorporation onto an article of clothing further comprises incorporation onto a neck strap.

8. The permission-status conditioning apparatus of claim 1, where said permission unit adapted to be worn by the trainee by incorporation onto an article of clothing further comprises incorporation onto a band.

9. The permission-status conditioning apparatus of claim 1, where said permission unit adapted to be worn by the trainee by incorporation onto an article of clothing further comprises incorporation onto a wearable badge.

10. The permission-status conditioning apparatus of claim 1, where said control unit adapted to transmit the granting of permission by the trainer further comprises an application implemented on an existing communications device.

11. A permission-status conditioning method comprising:
(i) providing a permission-status conditioning apparatus, further comprising:
(a) a control unit adapted to transmit the granting of permission by the trainer, further comprising a permission-transmitting unit adapted to transmit a wireless signal indicating such granting of permission;
(b) a permission unit adapted to be worn by the trainee by incorporation onto an article of clothing;
(c) a permission-receiving unit incorporated into said permission unit adapted to receive a wireless signal sent by said permission-transmitting unit indicating whether permission is granted by the trainer; and
(d) at least one permission indicator incorporated into said permission unit adapted to indicate to the trainee whether permission is granted by the trainer; and
(ii) using said permission-status conditioning apparatus for conditioning a trainee to obtain and wait for permission from a trainer before touching a target object.

12. The permission-status conditioning method of claim 11, where said permission indicator further comprises a positive indicator light.

13. The permission-status conditioning method of claim 11, where said permission indicator further comprises a sound indicator.

14. The permission-status conditioning method of claim 11, where said permission indicator further comprises a negative indicator light.

15. The permission-status conditioning method of claim 11, where said at least one permission indicator further comprises at least two said permission indicators.

16. The permission-status conditioning method of claim 11, where said permission unit adapted to be worn by the trainee by incorporation onto an article of clothing further comprises incorporation onto a glove.

17. The permission-status conditioning method of claim 11, where said permission unit adapted to be worn by the trainee by incorporation onto an article of clothing further comprises incorporation onto a neck strap.

18. The permission-status conditioning method of claim 11, where said permission unit adapted to be worn by the trainee by incorporation onto an article of clothing further comprises incorporation onto a band.

19. The permission-status conditioning method of claim 11, where said permission unit adapted to be worn by the trainee by incorporation onto an article of clothing further comprises incorporation onto a wearable badge.

20. The permission-status conditioning method of claim 11, where said control unit adapted to transmit the granting of permission by the trainer further comprises an application implemented on an existing communications device.
